(19) United States
(12) Patent Application Publication
(10) Pub. No.: US 2017/0259265 A1
(43) Pub. Date: Sep. 14, 2017

(54) MICROFLUIDIC PARTICLE SORTER

(71) Applicant: Bio-Rad Laboratories, Inc., Hercules, CA (US)

(72) Inventors: Eric DILLER, Toronto (CA); Jiachen ZHANG, Toronto (CA); Amir SADRI, Hercules, CA (US); Nenad KIRCANSKI, Hercules, CA (US)

(21) Appl. No.: 15/453,254

(22) Filed: Mar. 8, 2017

Related U.S. Application Data
(60) Provisional application No. 62/305,179, filed on Mar. 8, 2016.

(51) Int. Cl. B01L 3/00; G01N 21/64

(52) U.S. Cl. CPC B01L 3/502761; B01L 3/502738; G01N 21/6428; B01L 2400/0633; B01L 2200/0652; B01L 2300/0627; B01L 2200/143; G01N 2021/6439; G01N 15/1434

(57) ABSTRACT

Devices, systems and methods for sorting particles are provided. In one embodiment, a particle sorting device includes a microfluidic channel in a substrate formed of optically clear material and a diverter formed of magnetically responsive material in the microfluidic channel and capable of being rotated by a magnetic torque. Systems and methods are also described and illustrated.

This application claims the benefit of U.S. Application 62/305,179 filed on Mar. 8, 2016 which is hereby incorporated by reference in its entirety.

### BACKGROUND

A commercially available particle sorter is based on fluorescence-activated particle sorting or flow cytometry. Flow cytometers sort cells based on a fluorescence signal from a tag affixed to the cell of interest. The cells are diluted and suspended in a sheath fluid, and then separated into individual droplets via rapid decompression through a nozzle. After ejection from a nozzle, the droplets are separated into different bins electrostatically, based on the fluorescence signal from the tag. Among the issues with these systems are cell damage or loss of functionality due to the decompression, difficult and costly sterilization procedures between samples, inability to re-sort sub-populations along different parameters, and substantial training necessary to own, operate and maintain these large, expensive instruments. For at least these reasons, use of flow cytometers has been restricted to large hospitals and laboratories and the technology has not been accessible to smaller entities.

### SUMMARY

Disclosed herein are devices, systems and methods for sorting particles.

In an embodiment, a particle sorting device includes a microfluidic channel in a substrate formed of optically clear material and a diverter formed of magnetically responsive material in the microfluidic channel and capable of being rotated by a magnetic torque. In some embodiments, the diverter is formed from flexible silicone elastomer doped with permanent magnetic microparticles. In certain embodiments, magnetic microparticles are formed from neodymium-iron-boron. In some embodiments, a distance between the diverter and an upper or a lower surface of the microfluidic channel is between 10 micrometers and 20 micrometers. In certain embodiments, the diverter has a rod or beam shape. In some embodiments, the diverter comprises a fixed end that anchors the diverter to the substrate and a free end that projects into the lumen of the microfluidic channel. In some embodiments, the free end of the diverter projects downstream in the microfluidic channel. In certain embodiments, the free end of the diverter projects upstream in the microfluidic channel.

In an embodiment, a system includes a particle sorting device having a microfluidic channel in a substrate formed of optically clear material and a diverter formed of magnetically responsive material in the microfluidic channel and capable of being rotated by a magnetic torque; an electromagnetic source for applying a magnetic torque to the diverter external to the particle sorting device; a light source for illuminating the microfluidic channel and a detector for detecting a signal emitted from a target particle having an optically detectable label, wherein the light source and the detector are located upstream of the diverter; and circuitry operably connected to the detector and the electromagnetic source and configured to apply current to the electromagnetic source in accordance with a signal detected from the target particle. In some embodiments, the electromagnetic source comprises two opposing coils placed in close proximity around the particle sorting device and perpendicular to a fluid flow. In some embodiments, the system further comprises a structure in fluid communication with an inlet of the particle sorting device and configured to hydrodynamically focus a plurality of target and non-target particles to a center of a fluid stream flowing into the inlet.

In an embodiment, a method includes focusing a plurality of target and non-target particles in the center of the fluid stream in a particle sorting device by hydrodynamic focusing, the particle sorting device comprising includes a microfluidic channel in a substrate formed of optically clear material and a diverter formed of magnetically responsive material in the microfluidic channel and capable of being rotated by a magnetic torque; detecting a target particle in a fluid stream in the microfluidic channel, wherein the target particle comprises an optically detectable label; responsive to detecting the target particle, applying a magnetic torque to a diverter in the microfluidic channel, wherein the diverter is formed of magnetically responsive material; and diverting the target particle to a collection channel. In some embodiments, the diverter has a rod or beam shape. In certain embodiments, the diverter comprises a fixed end that anchors the diverter to the substrate and a free end that projects into the lumen of the microfluidic channel. In some embodiments, the free end of the diverter projects downstream in the microfluidic channel. In some embodiments, the free end of the diverter projects upstream in the microfluidic channel.

### BRIEF DESCRIPTION OF THE DRAWINGS

FIGS. 1A and 1B show schematic top views of a diverter in a microfluidic channel according to an embodiment of the invention. The microfluidic channel is part of a particle sorting device. Fluid flow is from right to left.

FIGS. 2A and 2B show schematic top views of two parallel diverters in a microfluidic channel according to another embodiment of the invention. The microfluidic channel is part of a particle sorting device. Fluid flow is from right to left.

FIG. 3 shows a schematic top view of a diverter in a microfluidic channel according to another embodiment of the invention. The microfluidic channel is part of a particle sorting device. Fluid flow is from left to right.

FIG. 4 shows a schematic side view of a diverter sandwiched between two spacers according to an embodiment of the invention.

FIG. 5 shows a schematic view of a system according to an embodiment of the invention.

FIG. 6 shows a schematic top view of a magnetic source (e.g., two opposing magnetic coils) surrounding a particle sorter according to an embodiment of the invention.

FIG. 7 shows a picture of a particle being sorted into an upper branch of a microfluidic channel in a particle sorting device. The picture was taken from a monitoring video.

FIG. 8 shows a picture of a particle being sorted into a lower branch of a microfluidic channel in a particle sorting device. The picture was taken from a monitoring video.

### DETAILED DESCRIPTION

Described herein are systems, devices and methods for sorting particles. Particle sorting systems, devices and methods have been discovered that can achieve fast sorting speeds. The particle sorting devices can also be manufactured by a cost effective process. The devices are designed for a single use and therefore do not require sterilization between samples.

As used in this specification and the appended claims, the singular forms “a”, “an”, and “the” include plural referents unless the content clearly dictates otherwise. Thus, for example, reference to a system comprising “a microfluidic channel” includes a system comprising one or microfluidic channels.

### Definitions

“Particle” refers to cells, both bacterial and eukaryotic, and to beads, where beads refer to inanimate particles, nanoparticles or microspheres and aggregates that may be formed from latex, polymer, ceramic, silicate, gel or a composite of such, and may contain layers. Beads are classified here on the basis of size as large (1.5 to about 50 microns), small (0.7-1.5 microns), or colloidal (<200 nm), which are also referred to as nanoparticles. Beads are generally derivatized for use in affinity capture of ligands, but some beads have native affinity based on charge, dipole, Van der Waal's forces or hydrophobicity.

“Microfluidic cartridge” refers to a device, card, or chip having a body or substrate within which are disposed microfluidic structures and internal channels having microfluidic dimensions, i.e., having at least one internal cross-sectional dimension that is less than about 500 μm and typically between about 0.1 μm and about 500 μm. These microfluidic structures may include chambers, lumens, walls, valves, vents, vias, pumps, inlets, nipples, membranes, optical windows, layers, electrodes, mixers, ribbon focusing annuli, and detection means, for example

“Microfluidic channel” refers to fluid passages within a microfluidic cartridge, the lumen of which has at least one internal cross-sectional dimension that is less than about 500 μm and typically between about 0.1 μm and about 500 μm. Microfluidic channels generally have upstream and downstream aspects or “ends” corresponding to inlet and outlet or to upstream junction and downstream junction. The lumen of a microfluidic channel is bounded by its walls.

“Label” or “labeling agent” refer to a composition detectable by spectroscopic, photochemical, biochemical, immunochemical, chemical, or other physical means. For example, useful labels include fluorescent dyes (fluorophores), fluorescent quenchers, luminescent agents, electron-dense reagents, enzymes (e.g., as commonly used in an ELISA), biotin, digoxigenin, 32P and other isotopes, haptens, proteins, nucleic acids, or other substances which may be made detectable, e.g., by incorporating a label into an oligonucleotide, peptide, or antibody specifically reactive with a target molecule or particle. The term includes combinations of single labeling agents, e.g., a combination of fluorophores that provides a unique detectable signature, e.g., at a particular wavelength or combination of wavelengths.

### Diverter

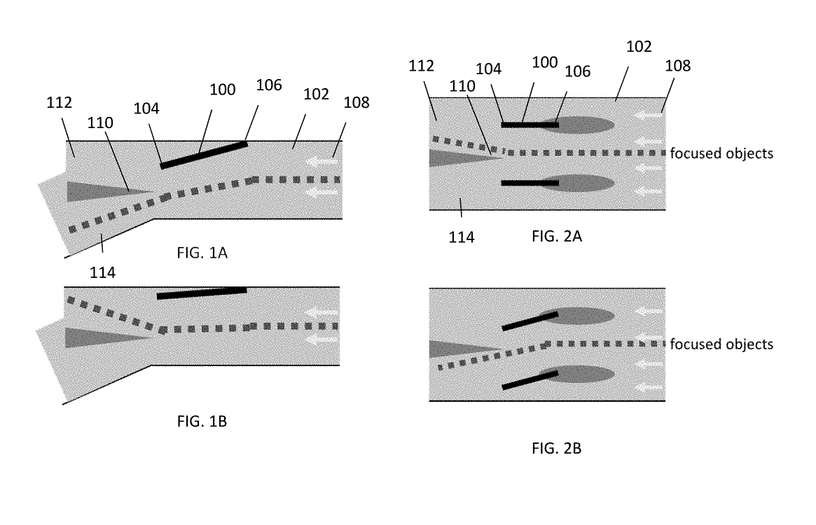

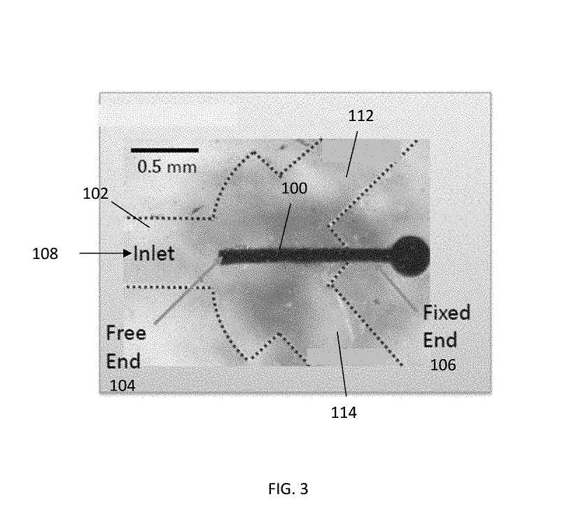

Referring to FIGS. 1A-3, embodiments of a diverter 100 in a microfluidic channel 102 in a particle sorting device (e.g., a particle sorting cartridge) are illustrated. The diverter 100 generally has a length greater than a width or depth and can have a rod or a beam shape. In some embodiments, the length of the diverter 100 ranges from 1-2 millimeters and the width ranges from 0.05 to 0.15 millimeters. The diverter has a free end 104 and a fixed end 106. The fixed end 106 anchors the diverter to a substrate and the free end 104 projects into the lumen of a microfluidic channel 102 either in the downstream direction (FIGS. 1A-2B) or upstream direction (FIG. 3) of fluid flow 108. In some embodiments, the diverter 100 is located at or near a bifurcated portion 110 of the microfluidic channel 102. One diverter (FIGS. 1A and 1B) or two parallel diverters (FIGS. 2A and 2B) can project into the downstream direction to divert fluid flow. In an embodiment having two diverters, the diverters can be located on either side of the bifurcation in the microfluidic channel (FIGS. 2A and 2B). In some embodiments, the diverter 100 has a length that is not sufficient to close a branch of the bifurcated microfluidic channel when the diverter 100 is rotated. In some embodiments, the diverter 100 has a length sufficient to close a branch of the bifurcated microfluidic channel when the diverter 100 is rotated.

The diverter 100 is formed of magnetically susceptible material such that, when a magnetic torque is applied to the diverter 100, the free end 104 of the diverter 100 can rotate and can divert fluid flow to an upper branch 112 or lower branch 114 of the bifurcated portion 110 of the microfluidic channel. In some embodiments, the diverter 100 is formed of flexible elastomeric polymer matrix doped with permanent magnetic microparticles. In some embodiments, the matrix is an elastomeric polymer including, but not limited to, polydimethylsiloxane (PDMS) or polyurethane. Exemplary magnetic microparticle materials include, but are not limited to, neodymium-iron-boron, samarium cobalt, alnico and ferrite. In some embodiments, the diverter 100 is manufactured by a soft lithography process in which neodymium-iron-boron particles (e.g., Magnequench MQP-15-7, 2 micron in size) are mixed with polyurethane matrix (e.g., Sylgard 184), the mixture is poured into a PDMS mold and is allowed to cure. The magnets are then placed by a pick and place process into the microfluidic channel in the particle sorting device. Prior to placement in the microfluidic channel, the diverter is magnetized in the horizontal or vertical planar direction to allow for actuation. In an embodiment having independent control of two diverters, one diverter is magnetized horizontally so that it responds to a vertically applied magnetic field and the other diverter is magnetized vertically so that it responds to a horizontally applied magnetic field. In this embodiment, independent control of two diverters can be achieved with a single input magnetic field.

In embodiments, diverter deflection is proportional to the diverter magnetization strength and applied magnetic field magnitude. Diverter deflection or bending moment, Q, can be described by the following equation:

Q=−∫τds Eq. 1

where:

$$τ = V \cdot {->}_{M} \times {->}_{B}$$

τ is the magnetic torque;

V is the volume of the hanging portion of the diverter;

\vec{M} is the magnetization;

\vec{B} is the magnetic field;

s is the coordinate along the diverter.

In some embodiments, high speed actuation of the diverter up to several thousand cycles per second can be achieved due to the low inertia of the diverter structure.

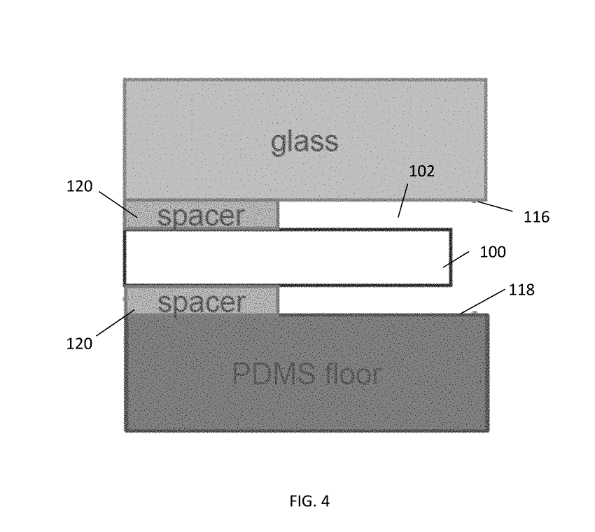

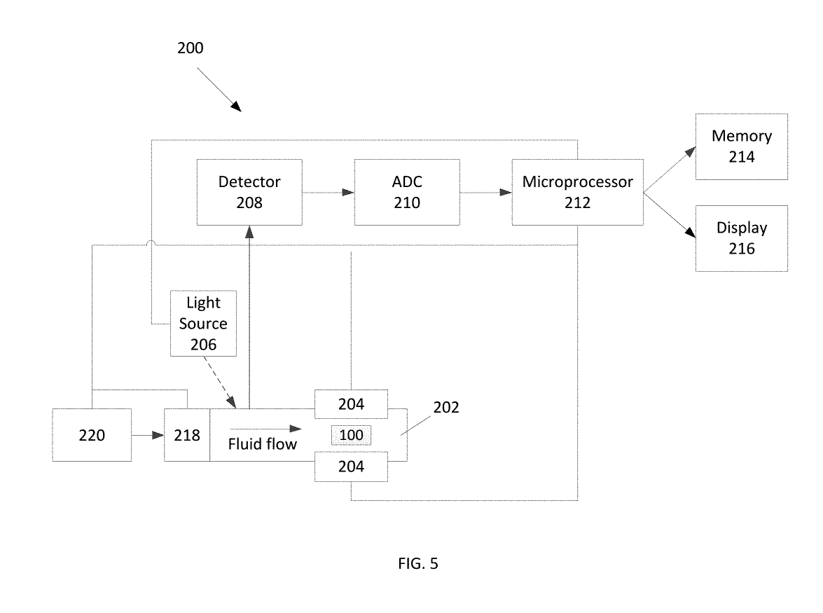

To ensure unimpeded rotation of the free end 104 of the diverter 100, the fixed end 106 of the diverter 100 is mounted such that a distance of 10-30 micrometers exists between the free end 104 and an upper surface 116 or a lower surface 118 of the microfluidic channel 102. In some embodiments, the distance between the free end 104 of the diverter 100 and the upper surface or the lower surface of the microfluidic channel 102 is 10-20 micrometers. In some embodiments, the fixed end 106 of the diverter 100 is anchored to the particle sorting device by sandwiching the fixed end 106 between two spacers 120 (FIG. 4). In some embodiments, the diverter 100 and the spacers 120 are fabricated as a single object. In the embodiment illustrated in FIG. 4, the lower surface 118 of the microfluidic channel 102 is formed from PDMS, the upper surface 116 of the microfluidic channel 102 is formed from glass, and the spacers 120 are formed from PDMS. Particle sorting devices with microchannels can be formed by soft-lithography techniques or by micro-injection molding.

### System

Referring to FIG. 5, a system 200 for sorting particles is illustrated. The system 200 includes a particle sorting device 202 (e.g., a particle sorting chip) having a diverter 100 in a microfluidic channel as previously described, an electromagnetic source 204 for applying a magnetic torque to the diverter 100, a light source 206 for illuminating the microfluidic channel and a detector 208 for detecting a signal emitted from a target particle having an optically detectable label.

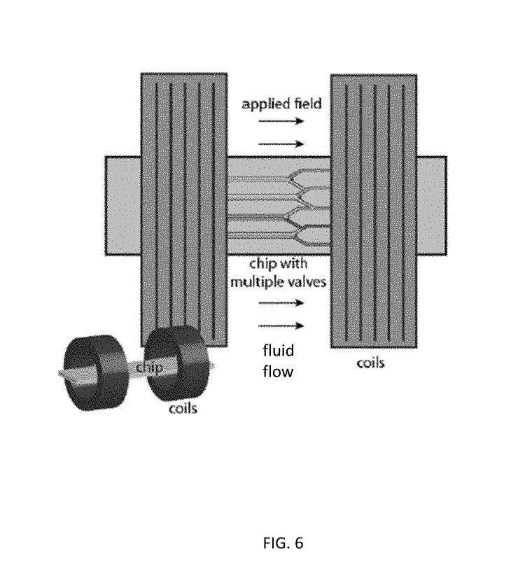

The electromagnetic source 204 is external to the particle sorting device 202. In an embodiment, the electromagnetic source 204 comprises two opposing coils placed in close proximity next to the particle sorting device 202 and parallel to fluid flow (See FIG. 5) to create uniform magnetic fields at the diverter location. In another embodiment in which two valves can be independently controlled (see FIG. 6), the electromagnetic source 204 comprises two opposing coils placed in close proximity around the particle sorting device 202 and perpendicular to fluid flow. In some embodiments, low-inductance coils are used with high coil current to give a large magnetic field with a fast switching time capability.

The light source 206 and the detector 208 are located upstream of the diverter 100. Depending on the signal to be detected, the light source 206 can provide light ranging from the ultraviolet range to the far infrared range. Exemplary light sources include lasers and light emitting diodes. In some embodiments, the light source 206 can provide light in multiple wavelength ranges.

In some embodiments, detection is achieved by colorimetric, fluorescent, phosphorescent or chemiluminescent detection. In some embodiments, detection is achieved by imaging such as by photography or by electronic detectors. Exemplary electronic detectors 208 include photodiodes, charge-coupled device (CCD) detectors, or complementary metal-oxide semiconductor (CMOS) detectors.

The analog signal from the detector 208 is digitized by an analog-to-digital converter 210. The digitized signal is processed by a microprocessor 212 to obtain at least one value or intensity of detected light that is stored in memory 214 and/or displayed on an optional display 216.

The system 200 includes circuitry operably connected to the detector 208 and the electromagnetic source 204 and configured to apply current to the electromagnetic source 204 in accordance with a signal detected from the target particle.

The system 200 further includes a structure 218 in fluid communication with an inlet of the particle sorting device 202 and configured to hydrodynamically focus a plurality of target and non-target particles to a center of a fluid stream (e.g., a sheath fluid) flowing into the inlet of the particle sorting device. In some cases, the structure 218 is a microfluidic device having grooves in a channel wall that direct the sheath fluid completely around the sample stream. An example of such a structure is described in Hashemi et. al. (2010) Lab Chip 10(15): 1952-1959. In some cases, the structure 218 is a microfluidic device having a sample channel and two sheath flow channels that merge into the downstream main channel where hydrodynamic focusing occurs. An example of a structure having two sheath flow channels is described in Chiu et. al. (2013) Lab Chip 13(9): 1803-1809 and Marek Dziubinski (2012) Hydrodynamic Focusing in Microfluidic Devices, Advances in Microfluidics, Dr. Ryan Kelly (Ed.), ISBN: 978-953-51-0106-2.

The system 200 can further include a fluid controller 220 that controls the velocity of fluid flowing through the particle sorting device 202. The fluid controller 220 can include pneumatic, hydraulic and/or one way valves, and can include a piston or a pump and associated fluidic passages. Fluid flow can be controlled by the fluid controller 220 in a feedback loop with the microprocessor 212 to keep, for example, particle velocity or fluid pressure constant.

### Method

In operation of the particle sorting system and device, fluid having target and non-target particles is focused in a center of a fluid stream in a particle sorting device by hydrodynamic focusing, the particle sorting device comprising a microfluidic channel in a substrate formed of optically clear material; and a diverter formed of magnetically responsive material in the microfluidic channel and capable of being rotated by a magnetic torque. A target particle that is optically labeled is then detected in the fluid stream in the microfluidic channel. In some embodiments, two or more optically labeled target particles are detected in the fluid stream in the microfluidic channel.

Responsive to detecting the target particle, a magnetic torque is applied to a diverter in the flow path. The target particle is then diverted to a collection channel. Non-target particles are diverted to a waste channel. In an embodiment having two or more optically labeled target particles, the target particles are diverted to the collection channel and non-target particles are diverted to the waste channel.

### EXAMPLES

The following examples are provided by way of illustration only and not by way of limitation. Those of skill in the art will readily recognize a variety of non-critical parameters that could be changed or modified to yield essentially the same or similar results.

### Example 1

This example illustrates the ability to divert particles when magnetic torque is applied to the diverter.

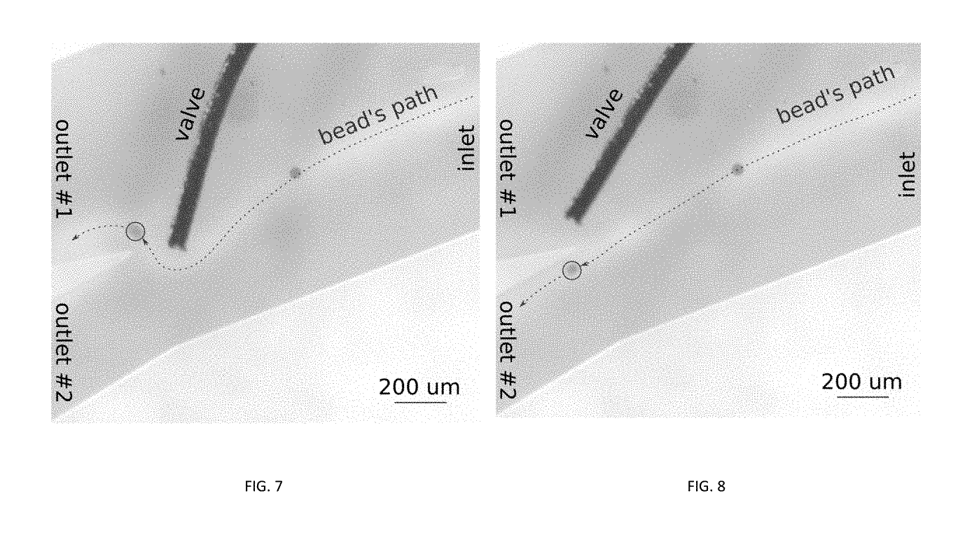

A PDMS particle sorting chip having a diverter valve made of neodymium-iron-boron particles (e.g., Magnequench MQP-15-7, 2 microns in size) mixed with polyurethane matrix (e.g., Sylgard 184) was used for this experiment. Polystyrene beads having a diameter of 38-45 microns in water with several drops of Tween 20 were pumped with horizontal focusing (as described in the aforementioned Hashemi et. al. (2010) Lab Chip 10(15): 1952-1959) into a microchannel of the particle sorting chip having a diverter with a free end in the downstream direction of fluid flow. The diverter free end was located near a bifurcation in the microchannel. The bifurcation resulted in an upper branch and a lower branch in the microchannel. Magnetic torque was applied to the diverter to move a polystyrene bead into the upper branch (e.g., outlet #1; FIG. 7) or into the lower branch (e.g., outlet #2; FIG. 8). Thus, magnetic torque can be used to move a diverter such that particles can be sorted into different channels.

All patents, patent applications, and other published reference materials cited in this specification are hereby incorporated herein by reference in their entirety.

What is claimed is:

1. A particle sorting device comprising:
a microfluidic channel in a substrate formed of optically clear material; and
a diverter formed of magnetically responsive material in the microfluidic channel and capable of being rotated by a magnetic torque.

2. The particle sorting device of claim 1, wherein the diverter has a beam shape.

3. The particle sorting device of claim 1, wherein the diverter comprises a fixed end that anchors the diverter to the substrate and a free end that projects into the lumen of the microfluidic channel.

4. The particle sorting device of claim 1, wherein the diverter is formed from flexible silicone elastomer doped with permanent magnetic microparticles.

5. The particle sorting device of claim 1, wherein the magnetic microparticles are formed from neodymium-iron-boron.

6. The particle sorting device of claim 1, wherein a distance between the diverter and an upper surface of the microfluidic channel is between 10 micrometers and 20 micrometers.

7. The particle sorting device of claim 1, wherein a distance between the diverter and a lower surface of the microfluidic channel is between 10 micrometers and 20 micrometers.

8. The particle sorting device of claim 3, wherein the free end of the diverter projects downstream in the microfluidic channel.

9. The particle sorting device of claim 3, wherein the free end of the diverter projects upstream in the microfluidic channel.

10. A system comprising:
a particle sorting device comprising:
a microfluidic channel in a substrate formed of optically clear material; and
a diverter formed of magnetically responsive material in the microfluidic channel and capable of being rotated by a magnetic torque;
an electromagnetic source for applying a magnetic torque to the diverter external to the particle sorting device;
a light source for illuminating the microfluidic channel and a detector for detecting a signal emitted from a target particle having an optically detectable label, wherein the light source and the detector are located upstream of the diverter; and
circuitry operably connected to the detector and the electromagnetic source and configured to apply current to the electromagnetic source in accordance with a signal detected from the target particle.

11. The system of claim 10, wherein the electromagnetic source comprises two opposing coils placed in close proximity around the particle sorting device and perpendicular to a fluid flow.

12. The system of claim 11, further comprising a structure in fluid communication with an inlet of the particle sorting device and configured to hydrodynamically focus a plurality of target and non-target particles to a center of a fluid stream flowing into the inlet.

13. The system of claim 10, wherein the diverter is formed from flexible silicone elastomer doped with permanent magnetic microparticles.

14. The system of claim 13, wherein the magnetic microparticles are formed from neodymium-iron-boron.

15. The system of claim 10, wherein a distance between the diverter and an upper surface of the microfluidic channel is between 10 micrometers and 20 micrometers.

16. The system of claim 10, wherein a distance between the diverter and a lower surface of the microfluidic channel is between 10 micrometers and 20 micrometers.

17. The system of claim 10, wherein the diverter has a beam shape.

18. The system of claim 10, wherein the diverter comprises a fixed end that anchors the diverter to the substrate and a free end that projects into the lumen of the microfluidic channel.

19. The system of claim 18, wherein the free end of the diverter projects downstream in the microfluidic channel.

20. The system of claim 18, wherein the free end of the diverter projects upstream in the microfluidic channel.

21. A method for sorting particles comprising:
focusing a plurality of target and non-target particles in the center of the fluid stream in a particle sorting device by hydrodynamic focusing, the particle sorting device comprising:
a microfluidic channel in a substrate formed of optically clear material; and
a diverter formed of magnetically responsive material in the microfluidic channel and capable of being rotated by a magnetic torque;
detecting a target particle in the fluid stream in the microfluidic channel, wherein the target particle comprises an optically detectable label;
responsive to detecting the target particle, applying a magnetic torque to a diverter in the microfluidic channel, wherein the diverter is formed of magnetically responsive material; and
diverting the target particle to a collection channel.

22. The method of claim 10, wherein the diverter has a beam shape.

23. The method of claim 10, wherein the diverter comprises a fixed end that anchors the diverter to the substrate and a free end that projects into the lumen of the microfluidic channel.

24. The method of claim 23, wherein the free end of the diverter projects downstream in the microfluidic channel.

25. The method of claim 23, wherein the free end of the diverter projects upstream in the microfluidic channel.
